(19) United States
(12) Patent Application Publication
(10) Pub. No.: US 2003/0159559 A1
(43) Pub. Date: Aug. 28, 2003

(54) Shears for cutting off sections from a material tape, especially a steel-cord tape, pulled through by means of a gripping device

(76) Inventor: Bernd Hoffmann, Burgkunstadt (DE)

Correspondence Address: JORDAN AND HAMBURG LLP, 122 EAST 42ND STREET, SUITE 4000, NEW YORK, NY, 10168, US

(21) Appl. No.: 10/308,598

(22) Filed: Dec. 3, 2002

(30) Foreign Application Priority Data
Jan. 30, 2002 (DE) 102 03 447.8-14

(51) Int. Cl. B26D 1/06

(52) U.S. Cl. 83/152; 83/277; 83/694

(57) ABSTRACT

Shears for cutting off sections from a material tape, especially a steel cord tape, pulled through by means of a material gripper of a gripping device, with a stationary lower knife and an upper knife, which can be moved relative to the lower knife, and a delivery belt, consisting of a plurality of parallel sectional belts, below the upper knife is disposed, an overarm, which laterally embraces the sectional belt of the delivery belt lying above it, being disposed, which supports the material tape during the cutting process and can be moved downward with the upper knife, the trailing end of the cut-off tape section being clamped and secured in position.

The invention relates to shears for cutting off sections from a material tape, especially a steel-cord tape, pulled through by means of a gripper device, and for depositing the sections on a delivery belt, which is disposed below the plane of the material tape, which coincides essentially with the cutting edge of the lower knife and consists of several parallel sectional belts.

In the case of such shears, the danger exists that the cut sections, which fall down under their own weight onto the delivery belt, strike the latter in a twisted position, so that, for the subsequent, further processing, which usually involves splicing them to one another, they are not in the correct position or must be aligned once again by expensive measures.

It is therefore an object of the invention to configure shears of the type mentioned, so that the sections, which are to be cut off, are fixed in position during the whole of the cutting process and while they are being deposited on the delivery belt, so that any distortion or tilting is prevented.

Pursuant to the invention, this objective is accomplished owing to the fact that, below the upper knife, an overarm is disposed, which laterally embraces the sectional belt of the delivery belt lying above it, supports the material tape during the cutting process and can be moved downward with the upper knife, the trailing end of the cut-off tape section being clamped and secured in position.

By means of such an overarm, the upper edges of which preferably should extend parallel to an upper knife, which is inclined at a cutting angle with respect to the lower knife and which, in a development of the invention, can consist of a plurality of shorter, individually movable overarm sections, the cut-off section is already held by clamping during the cutting process, this clamping still being maintained also during the subsequent downward movement of overarm and upper knife, so that the trailing end of the cut-off section is absolutely fixed in position until shortly before the final lowering onto the delivery belt. By these means, the aforementioned danger of distortion or of faulty orientation of the position of the cut-off section on the delivery belt is avoided, so that a subsequent splicing process can be carried out with accurately aligned sections, without any expensive, subsequent adjustment of the position of the sections.

In a further development of the invention, a magnet or a suction strip, which holds the material tape, is disposed in the support area of the overarm. The rear edge of the tape section, which is to be cut off, is always held by this magnet, embedded in the upper edge of the overarm, or by a suction strip, running parallel thereto, especially also when the upper knife leaves the lower dead-center position. If the tape were not held by a magnet or a suction strip, the danger would exist that the upper knife does not raise the end of the tape strip.

In a further development of the invention, provisions can be made advantageously that elevated fasteners, which correspond to the overarm and can be moved downward hydraulically essentially synchronously with the overarm for depositing the tape section on the delivery belt, are assigned to the remaining sectional belts of the delivery belt. In the following, “hydraulic” is always understood to mean that liquid as well as gaseous media can be used.

As a result of this measure, the tape section, which is to be cut off, rests on and is supported by the overarm and the elevated fasteners. In addition, fixed at one end, it is moved downward onto the delivery belt, so that there is no danger whatsoever anymore of a wrong orientation or distortion.

Pursuant to a further distinguishing feature of the present invention, each overarm section is guided, so that it can be shifted by means of two guide rods, which are spaced apart and a first bilaterally acting hydraulic cylinder, which serves to raise the overarm section, is reversed upward when the upper knife is lowered to a lower counter pressure, only to be reversed downward upon tension shortly before reaching the lower dead-center position of the upper knife, in order to place the overarm section on a moveable stop, during the retraction of which the overarm section can be moved by the first hydraulic cylinder as far as its lowest end position below the delivery belt.

When the upper knife is lowered, the first hydraulic cylinder, which is in its upper position, is switched to a slight counter pressure in the upward direction, so that it can be moved downward, counter to its pre-tension, by the pressure of the upper knife. On the other hand, however, due to the slight counter pressure from below, the material tape is locked in position against the upper knife. Only shortly before the lower dead-center position of the upper knife is reached, of course, still some distance above the plane of the delivery belt, the first hydraulic cylinder is reversed, so that it moves downward automatically and no longer only due to the higher pressure of the upper knife, which has now been stopped and is being moved upward, in order to deposit the overarm section on a movable stop. Because the section is resting on the overarm section and the elevated fasteners, there can be no distortion or positional change of the section during the essentially synchronous downward movement. As soon as the moveable stop has been retracted, the overarm and, correspondingly also, the elevated fasteners move into their lowest position, approximately 30 mm further downward, and places the cut-off tape section onto the delivery belt, which is usually provided with position-fixing devices. These may be magnets, which are disposed in or below the belt, for attracting a steel cord tape or also suction nozzles formed by perforations in the delivery belt and suction boxes below, which suction the tape section to the sectional belts of the delivery belt.

Finally, it is also within the scope of the invention that the moveable stop is disposed at the vertically displaceable piston rod of a second hydraulic cylinder, which, after the overarm section is set down, is switched to be essentially pressureless.

The elevated fasteners, which, in principle, may also be constructed like the overarms and can be moved individually, may in a further development of the invention, also be constructed as metal sheets, which are placed on edge and are fastened at their ends on either side of the material tape jointly to hydraulic cylinders, by means of which, jointly controlled, they can be lowered differently in such a manner, that the supporting edges extend essentially parallel to the upper knife. With the lowering of the upper knife, which is inclined to the lower knife, onto a tape edge, initially the corresponding hydraulic cylinder and, with that, the elevated fastener at this end are lowered, so that the supporting edge, in the final analysis, is as inclined as the edge of the upper knife. After this inclined position is reached, both hydraulic cylinders, while retaining the inclined position of the elevated fasteners, then move further downward with the upper knife.

Further advantages, distinguishing feathers and details of the invention arise out of the following description of two examples and from the drawing, in which

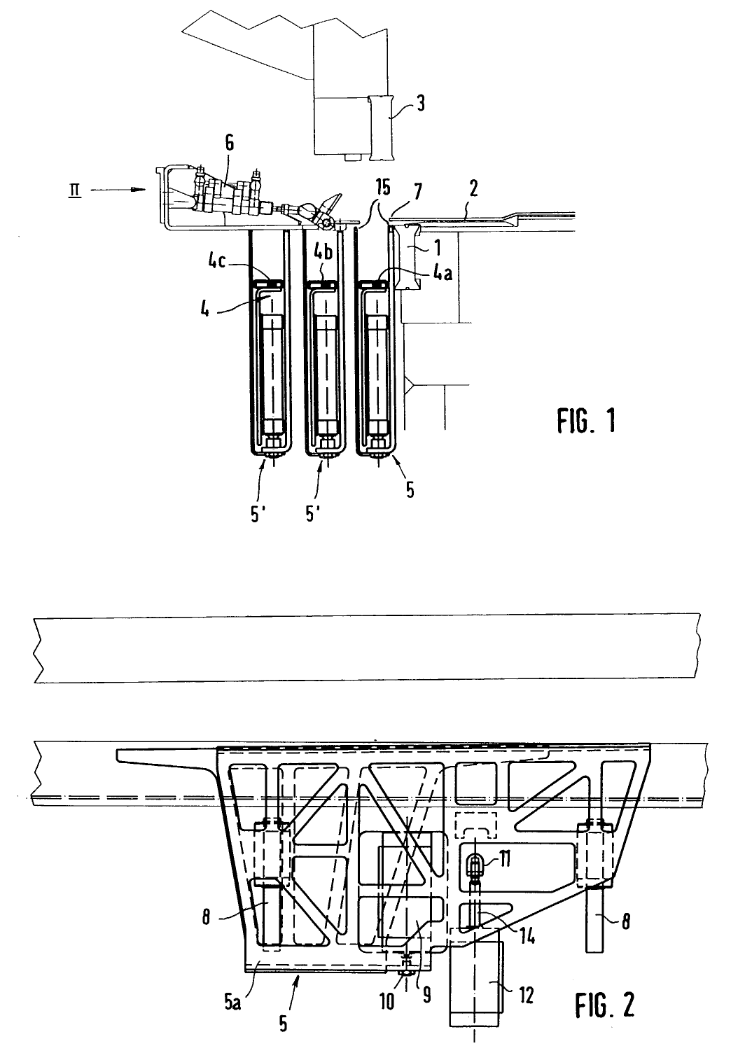

FIG. 1 shows a section through a first embodiment of shears with an inventive overarm device in the starting position before the material tape is pulled through the shears,

FIG. 2 shows a partial view, offset by 90° in the direction of arrow II of FIG. 1 without a material-gripping device,

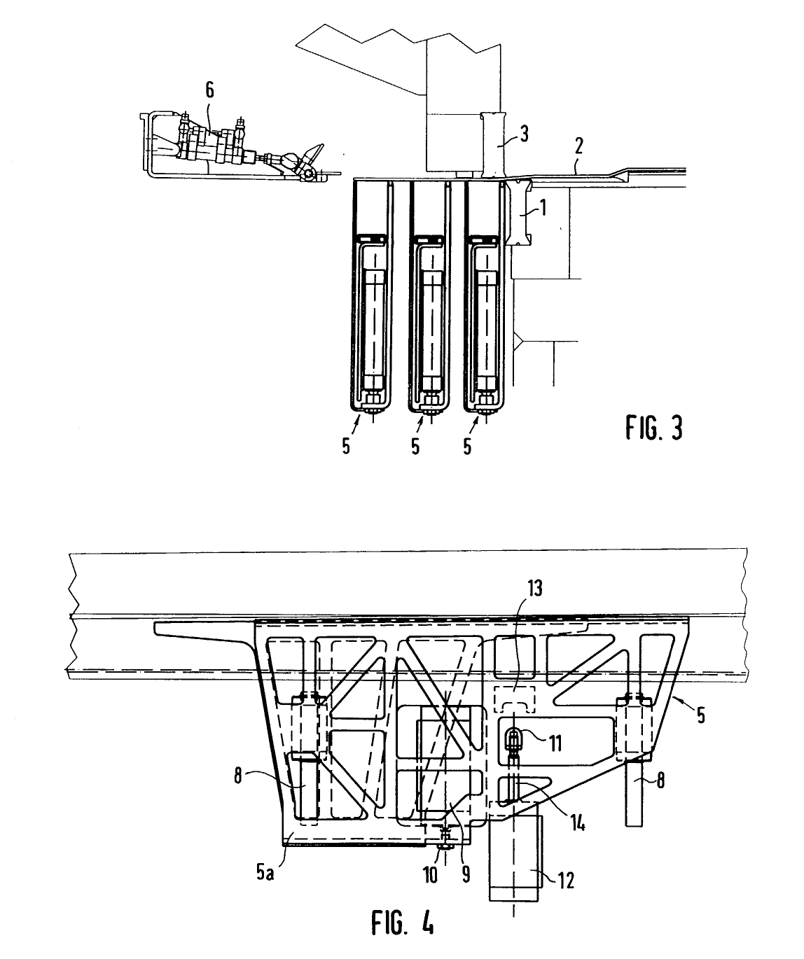

FIG. 3 shows a section corresponding to FIG. 1 at the start of the cutting process, that is, when the upper knife is placed on the material tape,

FIG. 4 shows an end view of the overarm section of FIG. 3,

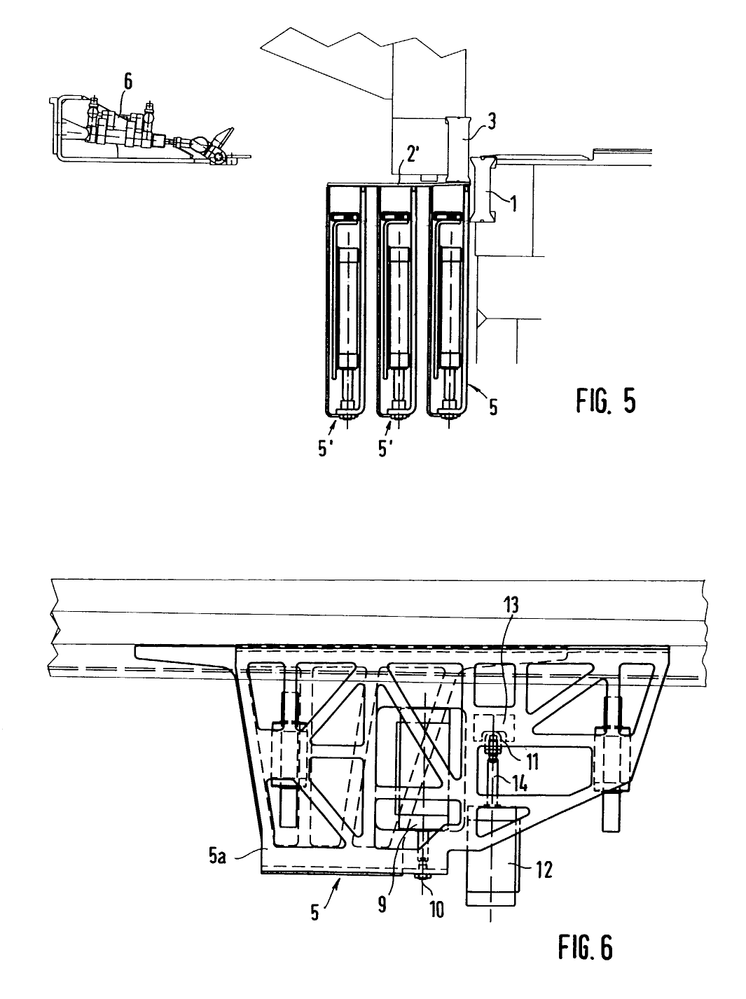

FIG. 5 shows a section through the shears in the region of the lower dead-center position of the upper knife,

FIG. 6 shows an end view of the overarm section in the operating position of FIG. 5,

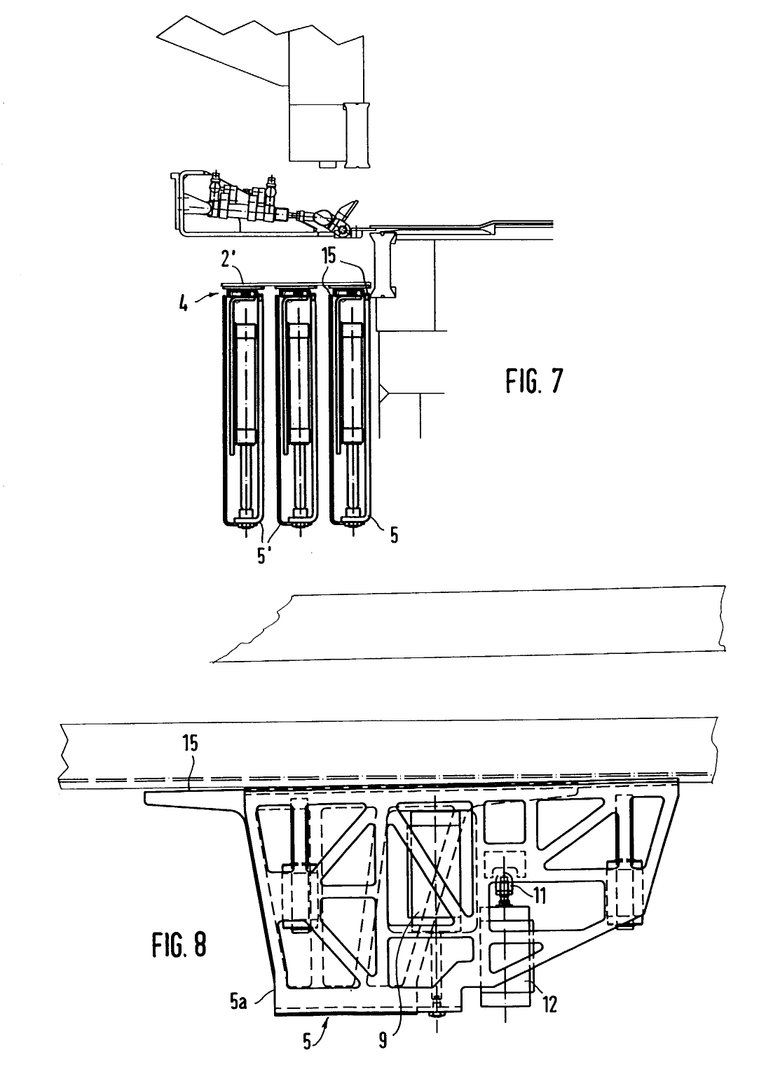

FIG. 7 shows a section though the shears after the upper knife is raised and after the final placement of the cut-off section on the delivery belt,

FIG. 8 shows a partial end view of an overarm section in the position of FIG. 7,

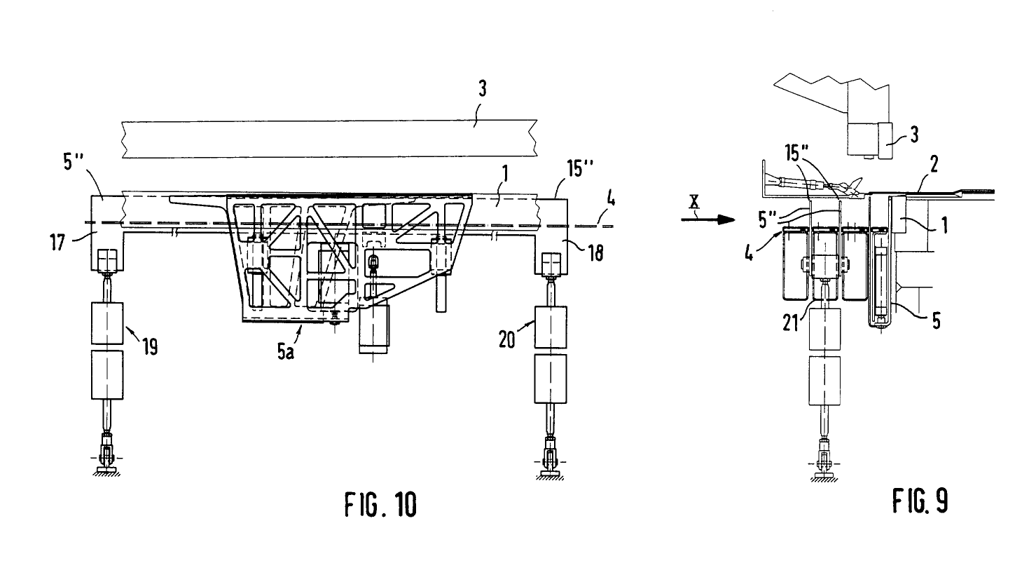

FIG. 9 shows a section, corresponding to FIG. 1, through a second embodiment of inventive shears with modified elevated fasteners,

FIG. 10 shows a partial view, offset by 90°, in the direction of arrow X in FIG. 9, without a material gripping device,

FIG. 11 shows a section through the shears in the region of the lower dead-center position of the upper knife (corresponding to FIG. 5 of the other example),

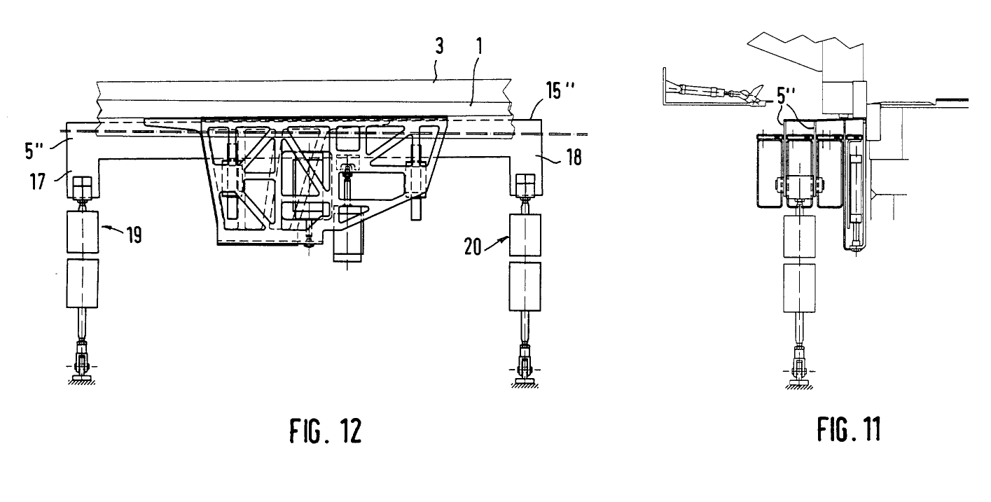

FIG. 12 shows an end view corresponding to FIG. 10 in the operating position of FIG. 9,

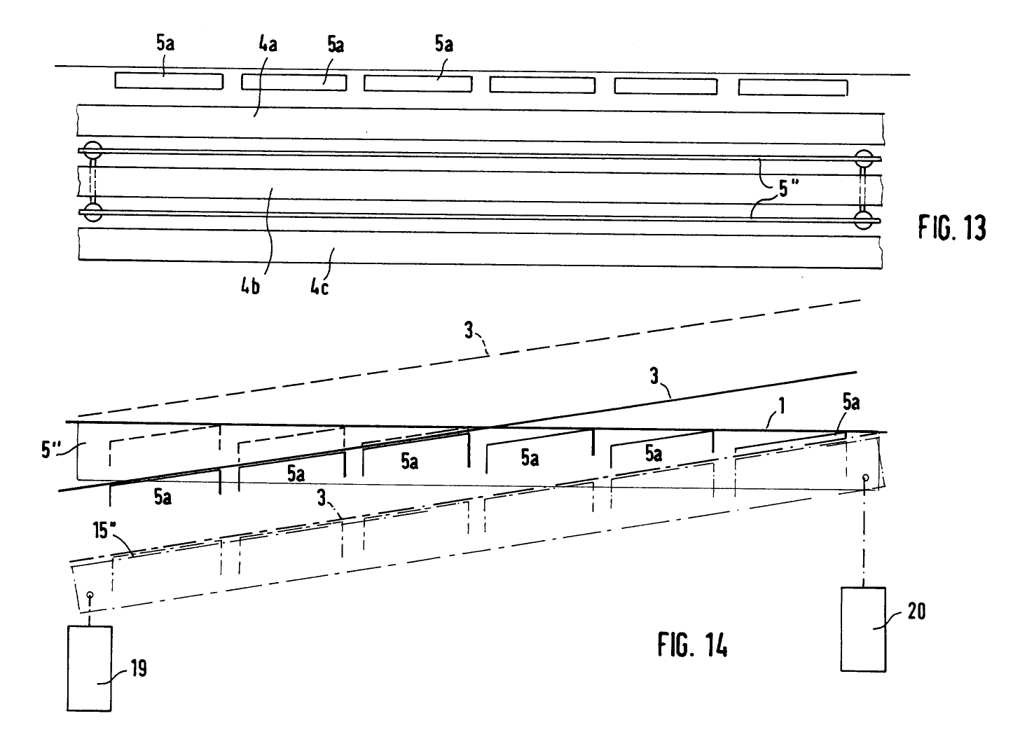

FIG. 13 shows a diagrammatic plan view of the overarm and elevated fastener and

FIG. 14 shows a diagrammatic side view of the divided overarm and the continuous elevated fastener in different lowered positions of the upper knife.

In FIG. 1, the stationary, lower knife, lying essentially in the transporting plane of the material tape 2, which is to be cut, can be seen at 1 and the upper knife of the shears, especially shears for cutting cord tape for the tire industry, and can be seen at 3. The delivery belt for transporting the cut-off tape section essentially perpendicularly to the feeding direction of the material tape 2, consists of a plurality of parallel sectional belts 4a, 4b and 4c and can be seen at 4. An overarm 5, which supports the material tape during the cutting process and, together with the upper knife, transports its downward while it is clamped and secured in position, is assigned to the sectional belt 4a, which is disposed below the upper knife 3. Appropriate supporting devices, such as the overarm 5, which function as elevated fasteners 5′, embrace the remaining sectional belts 4b and 4c of the delivery belt 4. These elevated fasteners 5′ are moved downward hydraulically and essentially synchronously with the overarm 5. Their control movement need therefore not be described in detail in the following.

Starting out from the position of FIG. 1, in which one material-gripping device 6 takes hold of the leading end 7 of the material tape 2, the material tape 2 is pulled through the shears and placed on the overarm 5 and the elevated fasteners 5′. After the material-gripping device is opened and retracted into the release position, the upper knife 3 is moved downward (FIG. 3), the material tape 2 being clamped between it and the upper edges of the essentially U-shaped overarm 5. As the upper knife 3 moves further downward and a material tape section 2′ is cut off, as shown in FIG. 5, the cut-off tape section 2′, clamped between the upper knife 3 and the overarm 5 and supported on the elevated fasteners 5′, which are also moving downward, is moved essentially in a horizontal plane aligned downward, as far as into an intermediate position, in which the overarm is bounded by a movable stop.

In practice, the overarm 5 preferably is formed by a plurality of shorter, individually displaceable overarm sections, of which only one overarm section 5a is shown in FIGS. 2, 4, 6 and 8. Adjoining these to the left and to the right, there are, of course, further such overarm sections. Each overarm section is guided by two guide rods 8, a first, double-acting hydraulic cylinder 9, the piston rod of which is connected at 10 with the overarm section 5a, being provided for the vertical displacement movement, as well as a second hydraulic cylinder 12, which carries a movable stop 1 1, which need only be constructed to act on one side.

While the cord tape 2 is being cut, that is, while the upper knife 3, starting out from the position of FIG. 3, is moved downward, the hydraulic cylinder 9 is pre-tensioned upward with a slight pressure, so that it pre-tensions the overarm section 5a upward with a slight, compressive force. This compressive force can easily be overcome by the upper knife 3, so that, when the upper knife 3 is moved downward into the position of FIG. 5, the overarm section 5a, with the cut-off tape section 2′ wedged between it and the upper knife 3, is pressed downward against the action of the hydraulic cylinder 10. Shortly before the lower dead-center position of the movement of the upper knife 3 is reached, a block 13 of the overarm section 5a, which is indicated by broken lines in the Figures, touches down on the moveable stop 11, which is, for example, a plastic part, at the free end of the piston rod 14 of the second hydraulic cylinder 12 shortly after the hydraulic cylinder 9 was reversed, so that, without the pressure of the upper knife 3, it automatically moves downward and, with that, takes the overarm section 5a along.

After the movable stop 11 is retracted, which preferably is accomplished by the pressureless switching of the hydraulic cylinder 12, the hydraulic cylinder 9, appropriately pre-tensioned downward as before, moves the overarm section, on which the trailing end of the cut-off section 2′ is resting, so far downward, that the supporting edges 15 of the U-shaped overarm 5 are below the plane of the delivery belt 4 (see, in particular, FIG. 7), so that the cut-off tape section 2′ rests on the sectional belts 4a, 4b, 4c of the delivery belt 4.

After the section 2′ is transported away with the help of the delivery belt 4, the overarm 5 and the elevated fastener 5′ move from the position of FIGS. 7 and 8 upward once again into the position of FIG. 1, in which then the tape 2 is pulled an appropriate distance through the shears and the cyclic course described above commences once more.

The modified example, shown in FIG. 9 to 12 differs from that of FIGS. 1 to 8 essentially due to the different construction of the elevated fasteners 5″. These are not constructed analogously to the overarms 1 as U-shaped components. Instead, the elevated fasteners 5″ are only metal sheets, which are placed on edge and the ends 17 and 18 of which are connected with one another on both sides of the material tape 2, 2′ by shackles 21, which are engaged by the hydraulic cylinders 19 and 20. Of course, the length of the elevated fasteners 5″ is the same as that of the overarm 5, which consists of several parts. In FIGS. 10 and 12, the end 17, 18, which actually is located further to the outside, is shown, only for reasons of clarity, next to one of the overarm sections 5a.

In FIGS. 13 and 14, it is shown once again by means of a diagrammatic plan view and side view how, when the upper knife is lowered, on the one hand, the overarm sections 5a are taken hold of one by one by the upper knife and pressed down and how, in particularly also the elevated fasteners, with the help of their hydraulic cylinders 19, 20, which are selected differently and have different regulating curves, are inclined in accordance with the edge of the upper knife during the cutting of the cord tape, so that the best possible support for the tape is achieved. For this purpose, in FIG. 14, the edge of the upper knife 3 is shown once in the starting position as a broken line, once in the partially lowered position, in which the cord tape is cut off only partly, as a solid line and once, in the lower dead-center position, as a line of dots and dashes. The position of the overarm sections 5a is shown in the same way by lines, which are broken, continuous or consist of dots and dashes. At the same time, the position of an elevated fastener 5″ is also shown once in the starting position, parallel to the lower knife 1, and once in the lower dead-center position of the upper knife, in which it can be seen that the elevated fasteners, left and right, have been lowered in different ways, so that their upper edge 15″ finally is parallel to the edge of the upper knife 3.

1. Shears for cutting off sections from a material tape, especially a steel cord tape, pulled through by means of a material gripper (6) of a gripping device, with s stationary lower knife (1) and an upper knife (3), which can be moved relative to the lower knife (1), and a delivery belt (4), consisting of a plurality of parallel sectional belts (4a, 4b, 4c), wherein, below the upper knife (3), an overarm (5) is disposed, which laterally embraces the sectional belt (4a) of the delivery belt (4) lying above it, supports the material tape (2) during the cutting process and can be moved downward with the upper knife (3), the trailing end of the cut-off tape section (2′) being clamped and secured in position.

2. The shears of claim 1, wherein the overarm (5) consists of a plurality of shorter overarm sections (5a), which can be shifted individually.

3. The shears of claim 2, wherein the upper edges (15) of the cross members of the preferably U-shaped overarm sections (5a) extend parallel to the upper knife (3), which is inclined at a cutting angle with respect to the lower knife (1).

4. The shears of one of the claims 1 to 3, wherein, a magnet (16) or a suction strip, which holds the material tape (2′), is disposed in the support region of the overarm (5):

5. The shears of one of the claims 1 to 4, wherein appropriate elevated fasteners (5′), which correspond to the overarm (5) and can be moved downward hydraulically essentially synchronously with the overarm (5) for depositing material sections (2′) on the delivery belt (4), are assigned to the remaining sectional belts (4b, 4c) of the delivery belt (4).

6. The shears of one of the claims 1 to 5, wherein each overarm section (5a) is guided, so that it can be shifted by means of two guide rods (8), which are spaced apart, and a first bilaterally acting hydraulic cylinder (9), which serves to raise the overarm section (5a), is reversed upward when the upper knife (3) is lowered to a low counter pressure, only to be reversed downward upon tension shortly before reaching the lower dead-center position of the upper knife (3), in order to place the overarm section (5a) on a moveable stop (11), during the retraction of which downward, the overarm section (5a) can be moved by the first hydraulic cylinder (9) as far as its lowest end position below the delivery belt (4).

7. The shears of claim 6, wherein the moveable stop (11) is disposed at the vertically displaceable piston rod (14) of a second hydraulic cylinder (12), which, after the overarm section (5a) is placed down, is switched to be essentially pressureless.

8. The shears of one of the claims 1 to 7, wherein the delivery belt (4) is provided with magnets or suction openings for fixing the position of the tape section placed upon it.

9. The shears of one of the claims 4 to 8, wherein the elevated fasteners (5″), which preferably are constructed as metal sheets set on edge, are fastened at their ends (17, 18), on either side of the material tape (2), jointly to hydraulic cylinders (19, 20), which, controlled, can be lowered differently in such a manner, that the supporting edges extend essentially parallel to the upper knife.
